(19) United States
(12) Patent Application Publication
(10) Pub. No.: US 2021/0325192 A1
(43) Pub. Date: Oct. 21, 2021

(54) Fine-Tuned Navigation Directions

(71) Applicant: GOOGLE LLC, Mountain View, CA (US)

(72) Inventors: Victor Carbune, Zurich (CH); Thomas Deselaers, Zurich (CH)

(21) Appl. No.: 16/620,786

(22) PCT Filed: Dec. 31, 2018
(86) PCT No.: PCT/US18/68234

§ 371 Date: Dec. 9, 2019

(51) Int. Cl. G01C 21/32; G01C 21/36; G01C 21/34; G06N 20/00; G06N 5/04

(52) U.S. Cl. CPC G01C 21/32; G01C 21/3691; G06N 5/04; G06N 20/00; G01C 21/3476

(57) ABSTRACT

A navigation system receives a request for navigation directions to a destination. In response to the request, the navigation system identifies a two-dimensional shape enclosing multiple access points, to which the destination is logically mapped. The navigation system further selects an access point from the multiple access points as a preferred destination, and generates navigation directions to the preferred destination in response to the request.

### FIELD OF THE DISCLOSURE

The present disclosure relates to systems and methods for providing navigation directions and, more particularly, to providing fine-tuned navigations directions to locations associated with geographic areas.

### BACKGROUND

The background description provided herein is for the purpose of generally presenting the context of the disclosure. Work of the presently named inventors, to the extent it is described in the background section, as well as aspects of the description that may not otherwise qualify as prior art at the time of filing, are neither expressly nor impliedly admitted as prior art against the present disclosure.

Today, numerous electronic devices such as personal computers, tablets, mobile phones, special-purpose navigators, etc. provide digital maps of geographic areas and step-by-step directions for navigating between geographic locations. The digital maps and/or navigation directions can be provided via special-purpose software applications such as mapping and navigation applications as well as via general-purpose software applications such as web browsers.

In some cases, these applications provide navigation directions to the geographic coordinates (e.g., latitude and longitude) of a certain place, which a user can specify by selecting a point on the map, for example. For some geographic entities, databases used by geographic services store a point with which the entity is associated for the purposes of navigation. Thus, for example, a train station with multiple platforms, a parking lot, various facilities, etc., can be mapped to a single point, and some geographic applications use this point to generate navigation directions to the train station. These geographic coordinates, however, do not always correspond to an optimal or even valid access point for the place.

In other cases, the user specifies an intersection of two streets, and the applications provide guidance to a street address at the intersection, but the street address may not correspond to an actual access point such as an entrance to a building. In yet other cases, a user can request driving directions to a natural park, a mountain, a shopping mall, etc., and the existing applications simply provide navigation directions to a point on a road near the geographic center of the corresponding area, which does not always correspond to a location from which users access the destination.

### SUMMARY

Generally speaking, a system of this disclosure receives a request for navigation directions to a certain destination and, in response, generates navigation directions to a location the user is likely to find convenient for accessing the destination, referred to below as an “access point.” In some cases, the request for navigation directions includes a set of geographic coordinates, such as latitude and longitude, and the system generates navigation directions to a street address proximate to the point with these geographic coordinates. In other cases, the request for navigation directions already includes a street address, but the system generates navigation directions to a refined street address or to a point that does not precisely coincide with the requested street address but defines a better access point to the destination. In still other cases, the request for navigation directions references a certain area, and the system generates navigation directions to an access point that does not necessarily coincide with the geometric center of the area. The system thus provides “fine-tuned,” rather than traditional, directions to destinations.

The system can determine a two-dimensional geometric shape encompassing multiple candidate access points for a destination as well as other points that are not candidate access points. To this end, the system can use satellite imagery, street-level photographs, photographs submitted by users, etc. to identify natural and/or artificial boundaries enclosing geographic areas. The system for some geographic entities generates a two-dimensional shape that encompasses more than the geographic entity alone. Thus, for example, the system can store, in a mapping database, a two-dimensional shape corresponding to the footprint of a certain landmark building and another two-dimensional shape that encloses the landmark building as well as one or more parking garages.

In various implementations, the system generates navigation directions to an access point in view of such signals as previous navigation requests from multiple users and other aggregate data, indications of previous navigation sessions to the destination of the user requesting the navigation directions, contextual signals related to the entity requesting the navigation directions (e.g., mode of transport of the user operating a navigation application, parameters of a web site directing visitors to a certain destination), etc.

In some implementations, the system uses these signals heuristically when selecting an access point from among multiple access points available for a destination. For example, when the destination is a national park, the system can select a hotel in or near the national park if the request for navigation directions arrives from a booking website. In other implementations, the system utilizes machine learning techniques to determine from which one or more locations users access the destination. More particularly, the system can construct and train a machine learning model to determine how users access various destinations under different circumstances. For example, users requesting navigation directions to a mountain may tend to access a hiking trail or a cable car from a certain parking lot, and the system can apply the machine learning model to identify this and similar access point. Further, the system in various implementation can apply real-time traffic data, satellite imagery, etc. to further adjust the destination in view of the potential delays between candidate access points and the destination, and select the optimal access point in view of these additional signals.

One example embodiment of these techniques is a computer-implemented method for providing navigation directions. The method includes receiving, by one or more processors, a request for navigation directions to a destination; identifying, by the one or more processors, a two-dimensional shape enclosing a plurality of access points, to which the destination is logically mapped; selecting, by the one or more processors, a particular access point from the plurality of access points as a preferred destination; and providing, by the one or more processors, navigation directions to the preferred destination in response to the request.

Another example embodiment of these techniques is a client device comprising one or more processors, a user interface, and a non-transitory computer-readable memory. The memory stores instructions that, when executed by the one or more processors, cause the client device to (i) transmit, to a server via a communication network, a request for navigation directions to a destination, (ii) receive, in response to the request, navigation directions to an access point selected from a plurality of access points logically mapped to a two-dimensional area including the destination, and (iii) provide the navigation directions via the user interface.

Yet another example embodiment of these techniques is a method in a computing system for determining a preferred access point for a destination. The method includes determining a two-dimensional shape representing a geographic area including a geographic entity, generating training data that includes (i) a plurality of destinations to which users requested navigation directions and (ii) for each of the plurality of destinations, respective locations within the geographic area to which the users travelled after completing respective navigation sessions to the corresponding destinations, training, using the training data, a machine learning model, and identifying, using the machine learning model, a preferred access point for a certain destination.

### BRIEF DESCRIPTION OF THE DRAWINGS

FIG. 1A is a block diagram of an example system in which techniques for providing fine-tuned navigation directions can be implemented;

FIG. 1B is a block diagram of an example machine learning model which the system of FIG. 1 can use to determine access points when generating fine-tuned navigation directions;

FIG. 2A is an example user interface screen which an existing mapping application can generate to provide navigation directions to a shopping mall encompassing a relatively large geographic area;

FIG. 2B illustrates example access points inside a two-dimensional shape corresponding to the shopping mall of FIG. 2, which the system of FIG. 1 can identify;

FIG. 2C is an example user interface screen which the mapping application of FIG. 1 can generate to provide fine-tuned navigation directions to a preferred destination selected from among the access points;

FIG. 3 illustrates example access points inside a two-dimensional shape corresponding to an example stadium, which the system of FIG. 1 can identify;

FIG. 4 is an example user interface screen which the mapping application of FIG. 1 can generate to provide fine-tuned navigation directions;

FIG. 5A is an example user interface screen which an existing mapping application can generate to provide navigation directions to a park;

FIG. 5B is an example user interface screen which the mapping application of FIG. 1 can generate to provide fine-tuned navigation directions to the park of FIG. 5A;

FIG. 6 is a flow diagram of an example method for determining a preferred access point for a destination using a machine learning model, which can be implemented in the server of FIG. 1;

FIG. 7 is a flow diagram of an example method for providing fine-tuned navigation directions, which can be implemented in the server of FIG. 1; and

FIG. 8 is a flow diagram of an example method for providing fine-tuned navigation directions, which can be implemented in the client device of FIG. 1.

### DETAILED DESCRIPTION

The system of this disclosure implements one or several techniques discussed below for generating fine-tuned navigation directions. Rather than always generating navigation directions to the geographic coordinates of the destination (or, when the destination corresponds to a certain area, the centroid of this area), the system of this disclosure can generate navigation directions to an access point from which the user can efficiently access the destination. To this end, the system in various implementations can use historical data and other aggregate signals, signals related specifically to the user requesting the navigation directions, contextual signals related to the time and place of the request for navigation directions, for example, etc.

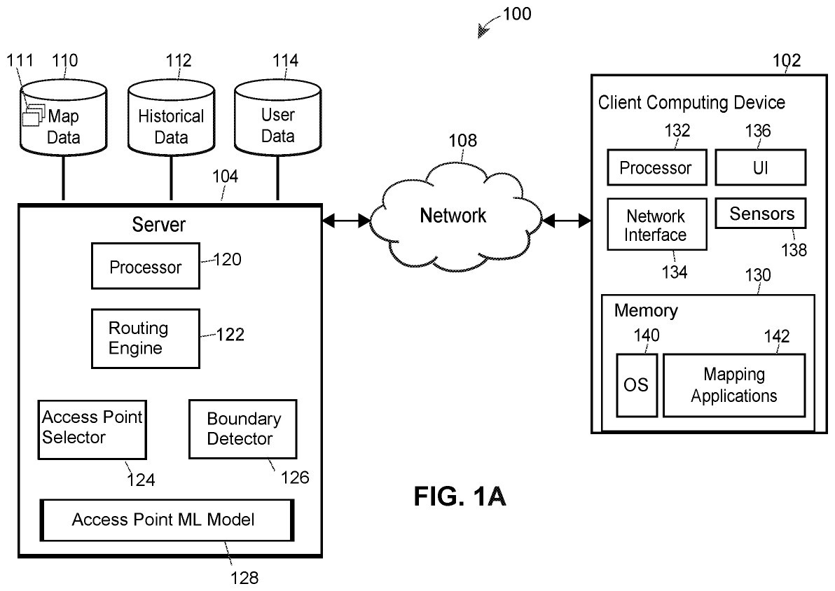

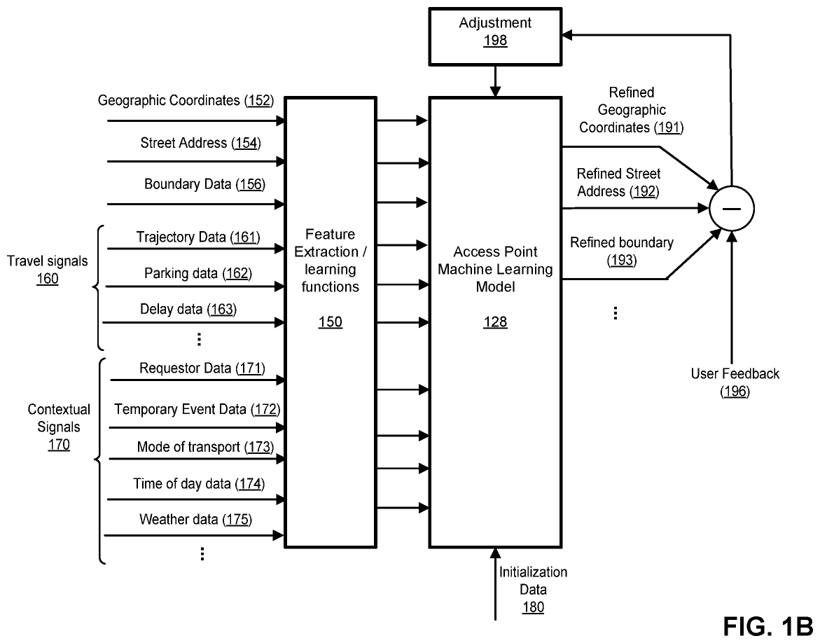

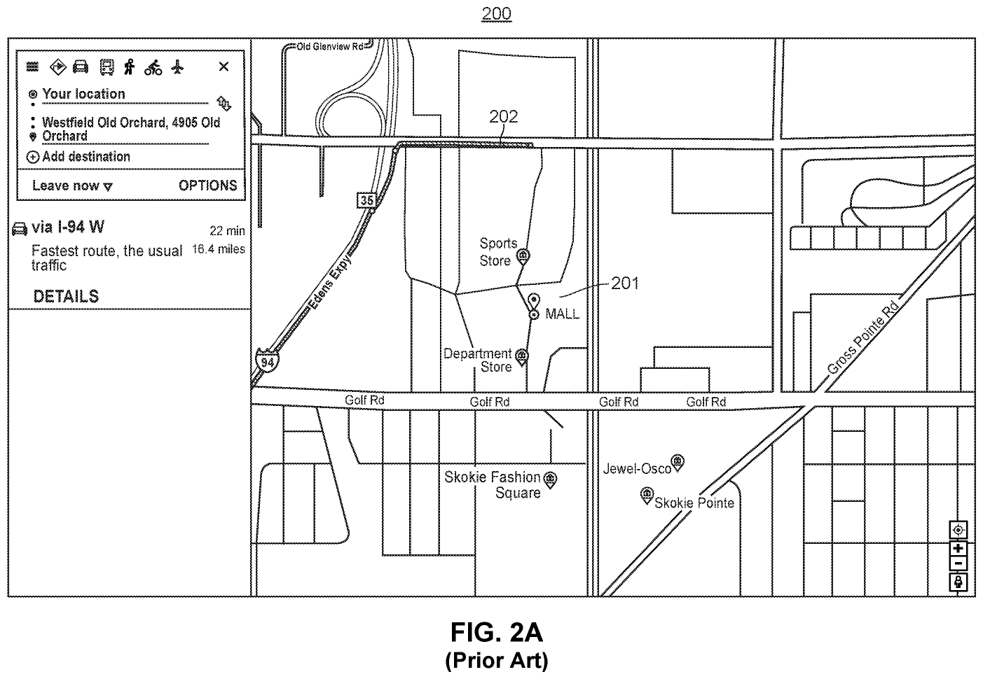

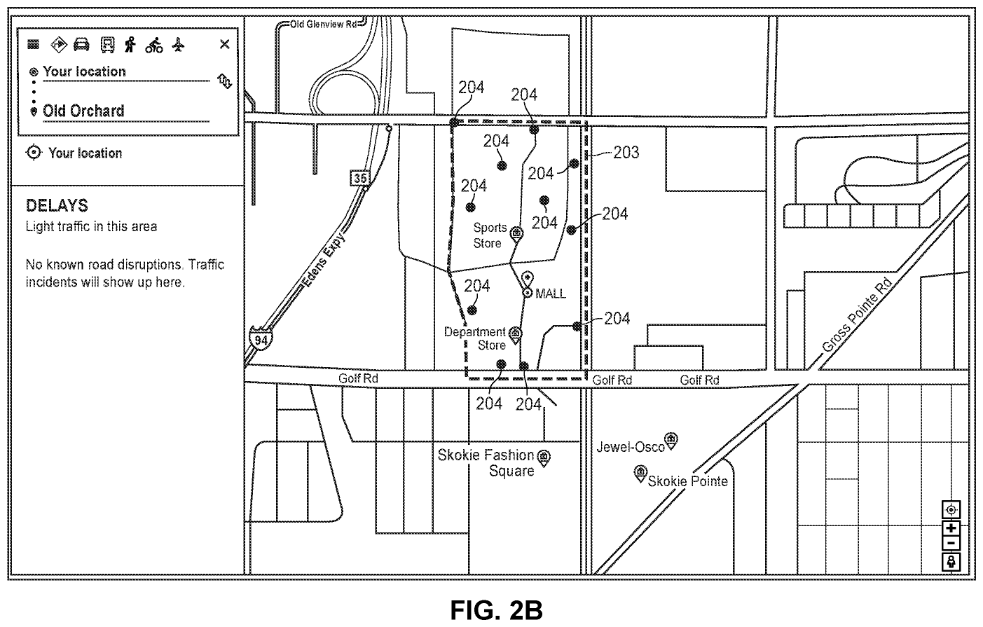

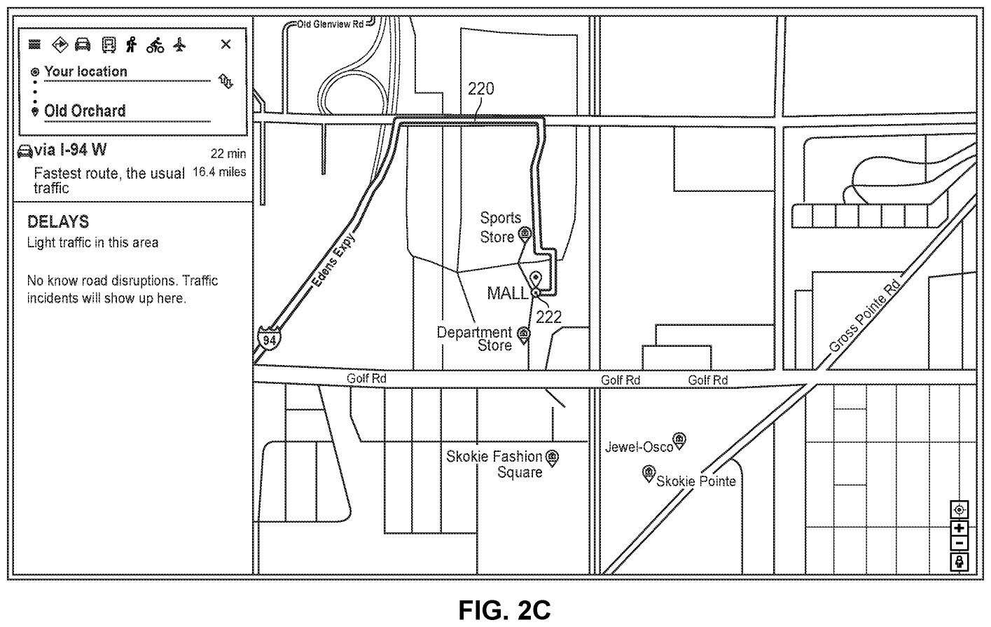

An example computing environment in which the system of this disclosure can operate is discussed first with reference to FIGS. 1A and 1B, followed by a discussion of several example use cases with reference to FIGS. 2A-5B, and further followed by a discussion of several example methods that can be implemented in the system of FIG. 1.

Referring to FIG. 1A, an example computing environment 100 in which the techniques outlined above can be implemented includes an example client computing device 102 which can be, for example, a personal computer, a portable device such as a tablet computer or smartphone, wearable computing device, a special-purpose car navigator, a device embedded in a head unit of a vehicle, etc. The computing environment 100 in general can include any suitable number of client computing devices.

The computing environment 100 further includes one or more servers 104 operated by a provider of mapping and navigation services. The server 104 can provide map data and navigation data to the client computing device 102 and other client devices. The computing environment 100 in general can include any suitable number of providers of content and/or databases related to transportation, such as providers of scheduling and routing information for trains, buses, ferries, etc. The server 104 and the client computing device 102 can communicate via a network 108, which can be a wide area network such as the Internet, for example, and include wired and/or wireless communication links.

The server 104 can be communicatively coupled to a database 110 that stores map data for various geographic areas. The map data can specify the shapes and various properties of geographic features such as roads, buildings, lakes, rivers, parks, etc. The map data can be stored in any suitable format such as vector graphics, rasterized images, text for labels, etc. and organized according to any suitable principle (e.g., square map tiles covering the same amount of area at a certain zoom level). The map data also can include street-level imagery and photographs taken from various vantage points. Further, map data for a geographic areas can include information about brick-and-mortar businesses located at the respective locations within the geographic area: hours of operation, description of products and services, user reviews, etc.

The map data 110 can include a set of two-dimensional shapes 111 representing geographic areas corresponding to footprints of real-world geographic features or, in some cases, geographic areas including multiple footprints of multiple geographic features. For example, one two-dimensional shape 111 can correspond to the footprint of a single building, another two-dimensional shape 111 can correspond to a shopping mall, yet another two-dimensional shape 111 can correspond to a natural park, etc. Other two-dimensional shapes 111 can represent geographic areas including several geographic features that commonly are associated with one another. For example, in a large metropolitan area, a two-dimensional shape 111 can encompass a popular landmark and a number of related nearby geographical features such as parking garages, hotels, restaurants, roadways, etc. As one example, a certain two-dimensional shape 111 can encompass a college campus including multiple buildings, paths, parks, etc. The two-dimensional shapes 111 in general can have any suitable size and shape, and multiple two-dimensional shapes 111 can cover a geographic area in an overlapping or non-overlapping manner. For example, the two-dimensional shapes 111 in one implementation are tiled so that the entirety of the map data is represented by two-dimensional shapes 111 that abut but do not overlap. In some cases, each point in a geographic area is mapped to at least one two-dimensional shape 111. As discussed in more detail below, a boundary detector 126 can generate descriptions of two-dimensional shapes 111 using satellite data, street-level imagery, photographs submitted by users, etc.

The two-dimensional shapes 111 also can enclose multiple access points, which can correspond to points of interest within the two-dimensional shape 111. For example, for a two-dimensional shape corresponding to a building, the corresponding access points may indicate entrances/exits of the building. In another example, for a two-dimensional shape corresponding to a shopping mall, the access points may correspond to entrances to the shopping mall, parking lots at the shopping mall, etc. The database 110 can store one or more access points along with additional information regarding the access point for at least some of the two-dimensional shapes 111. When the server 104 receives a request for navigation directions to an end point within one of the two-dimensional shapes 111, an access point selector 124 can select an access point as discussed in more detail below, and a routing engine 122 can generate navigation directions to this access point rather than the end point included in the request for navigation directions.

For at least some of the two-dimensional shapes 111, the database 110 can store weights or scores for the corresponding access points. The server 104 then can select the access point with the highest weight for the two-dimensional shape 111 as the preferred access point and thus as the destination for navigation directions. In operation, the server 104 can adjust the weights for access points, add access points, remove access points, etc. In other implementations discussed in more detail below, the server 104 uses a machine learning model to select access points from among multiple candidate access points based on a set of signals.

The server 104 also is coupled to a historical database 112 which stores anonymized trajectories for multiple users, each of which can be made up of position/time tuples, for example. In some implementations, users operate certain controls and/or install certain applications to indicate that the server 104 may use their navigation data to identify and select access points. In some cases, the anonymized user trajectories indicate how quickly users reach certain destinations after completing a navigation session, e.g., whether users can park after arriving at the destination (or tend to drive around for some time after reaching the destination), how much users tend to backtrack or walk after completing a navigation session, etc. Further, a user can operate certain controls and/or install certain applications to indicate that the server 104 can use the user's previous routes and trajectories when selecting access points for this user. Thus, for example, the data in the historical database 112 can indicate that whereas most users travelled to one access point in a geographic area, the user submitting a request for navigation directions previously travelled to another access point in the same geographic area.

The server 104 may also be communicatively coupled to a user database 114 that stores preferences, settings, etc. for users operating client devices such as the device 102. Similar to the examples above, users can operate certain controls and/or install certain applications to indicate that the server 104 can use their preferences, settings, etc. to personalize access points. As one example, user-specific data in the database 114 can indicate that a certain user previously accessed a destination via a certain access point, and, when the user subsequently requests navigation directions to the destination, the server 104 can select the access point the user prefers rather than the mostly commonly used access point.

In general, the server 104 can access any suitable number of databases such as those storing current traffic data, current weather data, commercial data (advertisements, offers, coupons, etc.), event data (e.g., music, movies, concerts), information regarding public transport (e.g., schedules for various types of public transport, locations of stations, access information for the stations), rideshare information, etc.

With continued reference to FIG. 1A, the server 104 includes one or more processors 120 and a non-transitory memory (e.g., a hard disk, a flash drive) storing instructions that implement a navigation system including a routing engine 122, an access point selector 124, and a boundary detector 126. The memory also can store an access point machine-learning model 128 discussed in more detail with reference to FIG. 1B. The instructions that implement the modules 122, 124, and 126 are executable on the one or more processors 120.

Using the map data stored in the database 110, a routing engine 122 can generate routes traversing geographic areas and the corresponding navigation directions. In particular, the routing engine 122 can receive a request for navigation directions from a client device such as the device 102. The request can include a start point and a destination (or the end point), and the access point selector 124 determines an access point corresponding to the destination. The routing engine 122 then can generate navigation directions to the access point.

The access point selector 124 in some implementations heuristically uses various aggregate signals from such sources as the database 112, user-specific signals from such sources as the database 114 and the client computing device 102, and contextual signals such sources as the client computing device 102, real-time weather services, news sources reporting temporary events, etc. to select an access point when servicing a request for navigation directions. As one example of applying a contextual signal heuristically, the map database 110 can store a two-dimensional shape 111 representing a natural park with several access points corresponding to a hotel, a visitors center, and a trailhead, respectively; when a request for navigation directions references the natural park generally, the access point selector 124 can select the location of the trailhead as the access point when the navigation request arrives from a hiking website, the location of the hotel when the navigation request arrives from a hotel booking website, and the location of the visitor's center in all other cases.

As an example of applying aggregate signals heuristically, the access point selector 124 can determine that most users who request navigation directions to a movie theater park in a garage one block south of the theater, and select the parking garage as the access point. Further, as an example of applying user-specific signals heuristically, the access point selector 124 can determine that a certain user typically uses street parking rather than parking lots or garages, and selects a street segment without parking restrictions nearest to the destination as an access point, when this information is available.

In general, the access point selector 124 can use the signals discussed above in any suitable combination and, in some cases, can assign respective weights to these signals when using combinations of signals heuristically. Thus, when different contextual signals indicate different access points, the access point selector 124 can use the respective weights to determine which signal should control. In other implementations, the access point selector 124 uses machine learning techniques as discussed with reference to FIG. 1B.

In some implementations, the access point selector 124 also operates in a batch mode to process a number of two-dimensional shapes 111, identify the corresponding access points, and store the access points in the database 110. In this manner, when the routing engine 122 services a request for navigation directions in real time, the access point selector 124 can select one of the previously identified access points from the map database 110.

In operation, the boundary detector 126 can analyze satellite imagery, street-level photographs, photographs submitted by users, etc. to identify walls, fences, natural obstacle, etc. to determine the boundaries of geographic entities. For example, the boundary detector 126 can determine that an area bounded by fences probably corresponds to a geographic entity and stores a description of the boundary as a polygon in the map database 110. Each polygon encloses a two-dimensional shape, such as the shape 111 discussed above. The boundary detector 126 in some implementations defines multiple shapes for the same location, to be used in accordance with different contexts. For example, the two-dimensional shape associated with a baseball stadium can be smaller when no games are scheduled, and larger just prior to and during games. Further, the boundary detector 126 can define two-dimensional shapes in an overlapping manner, and thus a certain parking garage located in a busy downtown area can be logically mapped to an office building during the day and to a nearby music venue at night (as used in this disclosure, logical mapping can refer to creating an association between geographic entities and geographic areas defined by shapes, or between multiple geographic entities). The routing engine 122 can determine that when a point with a certain geographic coordinates is within the polygon, the routing engine 122 should provide navigation directions to one of the access points enclosed by the polygon. As discussed above, the access point need not precisely match the geographic coordinate which the request for navigation directions specifies.

With continued reference to FIG. 1A, the client computing device 102 can include a memory 130, one or more processors 132, a network interface 134, a user interface (UI) 136, and sensors 138. The memory 130 can be a non-transitory memory and can include one or several suitable memory modules, such as random access memory (RAM), read-only memory (ROM), flash memory, other types of persistent memory, etc. The network interface 134 can support any suitable communication protocol to communicate with remote servers and other devices via the communication network 108. The UI 136 can include any suitable combination of input devices such as a touchscreen, a keyboard, a microphone, etc. and output devices such as screens, speakers, etc. Depending on the implementation, the one or more sensors 138 can include a global positioning system (GPS) module to detect the position of the client computing device 102, a compass to determine the direction of the client computing device 102, a gyroscope to determine the rotation and tilt, an accelerometer, etc.

The memory 130 stores an operating system (OS) 140, which can be any type of suitable mobile or general-purpose operating system. The memory 130 also stores a mapping and navigation application 142, which can be configured to generate interactive digital maps and output navigation directions. The mapping application 142 can receive map data in a raster (e.g., bitmap) or non-raster (e.g., vector graphics) format from the map data database 110 and/or the server 104. In some cases, the map data can be organized into layers, such as a basic layer depicting roads, streets, natural formations, etc., a traffic layer depicting current traffic conditions, a weather layer depicting current weather conditions, a navigation layer depicting a path to reach a destination, etc. The mapping application 142 can provide navigation directions as a graphic overlay on a digital map, as a sequence of instructions that include text and/or images, as a set of vocalization instructions via speakers, or any suitable combination thereof. The mapping application 142 can provide digital maps and navigation instructions natively via the UI 136 or in a projected mode via the head unit of a vehicle, for example.

For simplicity, FIG. 1A illustrates the server 104 as only one instance of a server device. However, the server 104 according to some implementations includes a group of one or more server devices, each equipped with one or more processors and capable of operating independently of the other server devices. Server devices operating in such a group can process requests from the client computing device 102 individually (e.g., based on availability), in a distributed manner where one operation associated with processing a request is performed on one server device while another operation associated with processing the same request is performed on another server device, or according to any other suitable technique. For the purposes of this discussion, the term “server” may refer to an individual server device or to a group of two or more server devices.

Now referring to FIG. 1B, the access point selector 124 in some implementations trains the access point machine-learning model 128 using various input signals, the corresponding labels, user feedback data, etc. The access point selector 124 can receive various inputs 152, 154, 156, 160, and 170 as training data and apply this data to the model 128, via feature extraction functions 150. For example, one of the functions 150 can process the trajectory of an anonymous user, received as a part of travel signals 160, to determine how long it took this user to arrive at the eventual destination after the navigation session completes, to generate a certain time metric; and another one of the functions 150 can measure the distance this anonymized user walked after parking to arrive at the destination. These metrics can correspond to a set of parameters associated with navigating a user to certain point in one instance, and can be included in a certain feature vector. The functions 150 can generate various feature vectors for multiple points, and associate sets of points with two-dimensional shapes (e.g., the two-dimensional shapes 111 stored in the database 110) corresponding to geographic entities.

In general, the access point selector 124 can train the model 128 using supervised learning, unsupervised learning, reinforcement learning, or any other suitable technique. The access point selector 124 can train the model 128 as a standard regression model. In those cases where the search space is large, the access point selector 124 can discretize the model 128 for groups of map tiles, for example.

In the example configuration of FIG. 1B, the training data includes geographic coordinates 150, street addresses 152, and boundary data 154 as inputs. As a more specific example, the dataset used for training can include geographic coordinates included in navigation requests, boundaries of geographic entities including these geographic coordinates, and street addresses to which the users travel when requesting navigation directions to these geographic coordinates, which can be used as labels during training.

The travel signals 160 can include aggregate user logs and/or anonymized individual signals that can be used in conjunction with other signals 152, 154, 156, and 170. The travel signals 160 can include trajectory data 161 that indicates, in part, whether a user tend to drive to a different location (e.g., a garage) after arriving at a certain destination (e.g., the street address included in the request for navigation directions), whether the user turned around after arriving at the destination, how long the user drove around before parking, whether the user walked to the destination after using transport, etc. Parking data 162 can indicate whether the user parked the car after arriving at the destination, whether the user walked to the destination after parking, etc. Delay data 163 can indicate the time between completing a navigation session and arriving at the destination.

As further illustrated in FIG. 1B, the access point selector 124 can train the model 128 further using contextual signals 170. For example, requestor data 171 can identify the source of the request for navigation directions (e.g., an application executing on client device, a website dedicated to particular type of activity or business, an email message related to a certain topic), at least because users accessing the same geographic location for different purposes may need different access points. For example, tourists visiting Chicago as well as locals may request navigation directions to the Willis Tower. Although both types of users may use the same navigation application (e.g., the application 142 of FIG. 1A) and specify the destination in the same manner, in some cases the navigation application can automatically identify certain types of users as tourists and accordingly select the visitor's entrance as the access point. For other users, the navigation application can select the tenant entrance as the access point. More generally, the requestor data 171 can identify the type of activity to which the request for navigation directions likely pertains.

In addition to, or instead of, identifying the type of activity, the requestor data 171 can include one or more parameters specific to the user associated with the request for navigation directions (provided the user indicated that the access point selector 124 can utilize these parameters in this manner, by operating certain controls and/or installing certain applications). Examples of parameters specific to the user can include an indication that the requestor is a tenant in the building that corresponds to the destination in the request for navigation directions (and accordingly may require the tenant entrance, can have a different requirement with respect to parking, etc.); an indication that the requestor may require special access points, such as wheelchair access; an indication that the requestor prefers staircases to elevators; an indication that the user prefers street parking to parking lots or garages, as discussed above with reference to heuristic techniques, etc.

The contextual signals 170 also can include temporary event data 172 identifying the times, the duration, and the types of activity related to a geographic entity (e.g., a street parade scheduled to begin at a certain time and expected to affect travel to the destination, parking at the destination, access to buildings). Further, the contextual signals 170 can include mode of transport data 173 identifying how users arrive at the destination. For example, users who bicycle to a certain destination may tend to select certain access points (e.g., due to availability of bicycle racks), while pedestrians may tend to select other access points, and drivers may tend to select still other access points at which car parking is available.

Still further, the contextual signals 170 can include time of day data that indicates when a certain navigation session occurred. Generally speaking, different access points may be preferable at different times due to traffic, for example. Although many navigation applications today account for traffic when generating navigation directions and attempt to select the optimal route in view of current traffic conditions, these systems navigate to the same destination. On the other hand, the model 128 can indicate to the access point selector 124 that the access point selector 124 should vary the destination in view of traffic. Similarly, the model 128 can adjust the destination in view of weather data 175, which the contextual signals 170 also can include. More generally, the contextual signals 170 signals can include any suitable number of signals, and the functions 150 accordingly can be configured to generate any suitable types of feature vectors. Examples of additional context signals 170 can include traffic (which sometimes, but not always, correlates with time of day and weather), day of the week (to account for places closed on weekends, for example), season, etc.

With continued reference to FIG. 1B, the access point selector 124 can initialize the model 128 using initialization data 180, which can include probabilities inversely proportional to distances to the candidate street addresses or other suitable references. For example, initialization data can include a point with certain geographic coordinates Pᵢ=(Latitudeᵢ, Longtitudeᵢ) or, in another implementation, Pᵢ=(Latitudeᵢ, Longtitudeᵢ, Elevationᵢ). The access point selector 124 can identify several locations in the vicinity of point Pᵢ, e.g., A₁=123 Elm St., A₂=125 Elm St., A₃=200 Main St., and A₄=202 Main St. The access point selector 124 initially can map point Pᵢ to the respective two-dimensional shapes associated with each of these four street addresses A₁-A₄, (which at this point also may be initial estimates subject to adjustment during training), with an estimated probability that point Pᵢ should map to the first street address based on the distance between Pᵢ and the centroid of A₁, an estimated probability that point Pᵢ should map to the second street address based on the distance between Pᵢ and the centroid of A₂, etc. During training, the model 128 can strongly bias the point Pᵢ to the two-dimensional shape associated with A₂, for example. Thus, when a user requests navigation directions to point Pᵢ or a nearby point, the access point selector 124 can use the model 128 to determine that the routing engine 122 should generate navigation directions to the street address A₂. Also, as a result of training, the model 128 can determine that a two-dimensional shape associated with the address A₂ encompasses various points including the point Pᵢ. Moreover, for larger-area destinations, the model 128 upon training can not only determine that point Pᵢ maps to the two-dimensional shape associated with the street address A₂, but also that this address has access points AP₁, AP₂, . . . AP_{N}, and select one of these access points as the preferred access point for a particular situation. In other implementations, the initialization data 180 can include the initial count of navigation sessions to the candidate access points. For example, for a certain geographic area A, points Pj to which navigation directions were requested in the past in the area A first can be clustered to reduce the complexity of the problem (e.g., points within 10 meters of each other can be clustered into a single point) to generate a set of candidate access points S={AP1, AP2, . . . APN), and respective counts of requests for navigation directions can be assigned to each of the candidate access points.

As illustrated in FIG. 1B, the model 128 can generate such predictions as refined geographic coordinates 191 (e.g., a mapping of point Pᵢ to point P′ᵢ), a refined street address 192 (e.g., “122 Elm St.” to “204 Main St.” to provide a better access to the building), a refined boundary 193 (i.e., adjustments to the two-dimensional shapes corresponding to various destinations). The access point selector 124 can apply user feedback 196, when available, to assess the quality of the predictions 191, 192, 193, etc. and continue tuning the model 128. To this end, an adjustment function 198 can receive a metric assessing the difference between the actual and expected outputs of the model 128, generate adjustment operations, and apply these operations to the model 128.

The user feedback 196 regarding navigation directions can include explicit and/or implicit indications of whether the access point was correct. For example, the client computing device 102 can transmit a request for navigation directions to the Willis Tower in Chicago, Ill., to the server 104. The access point selector 124 can identify several candidate access points, provide a corresponding indication to the routing engine 122, which in turn can cause the application 142 to generate a clarifying prompt asking whether the user prefers to navigation to the entrance used by tourists or the entrance used by tenants, located on a different street. Additionally or alternatively, after a navigation session to an access point for a certain destination completes, the routing engine 122 can cause the application 142 to generate a prompt asking whether the user is satisfied with the selected access point. On the other hand, implicit signals indicative of whether the access point selector 124 selected the right access point include the amount of time the user spent driving or walking after navigation to the selected access point, for example.

After the model 128 is sufficiently trained (as discussed above, the tuning process can continue even after the model 128 is sufficiently trained to continue improving the performance), the access point selector 124 can apply the model 128 to select access points for navigation directions. In particular, the access point selector 124 can receive a request for navigation directions and any suitable combination of additional contextual signals. The contextual signals the access point selector 124 uses in this case can be similar to the contextual signals 170 used to train the model 128, but in some cases the access point selector 124 also the user's preferences and/or the user's travel history (e.g., the access points the user selected in the past), provided the user indicated to the server 104 that the system can apply this data in this manner. The access point selector 124 can apply these signals to the model 128 to determine an access point.

In one example scenario, a driver requests navigation directions to Wrigley Field in Chicago, Ill. by typing in “Wrigley Field” as the destination. The server 104 can receive the request during a Chicago Cubs home game via a website that provides tourist information. In the absence of contextual signals, the access point selector 124 may select the main entrance of the stadium located at the intersection of Clark and Addison streets in Chicago as the destination. However, because the driver may not easily reach the main entrance during home games, the model 128 can predict that the user will find a nearby parking lot to be a better access point in view of the contextual signals indicating the temporary event (the game) and the likely user type (tourist). In another example, the access point selector 124 can receive a request for navigation directions to a certain neighborhood (e.g., Mission in San Francisco, Calif.) along with several contextual signals: rainy weather, nighttime, and the user being local to the Bay Area. The access point selector 124 can apply these contextual signals to the model 128 to obtain a prediction that a certain intersection is most likely to serve as a suitable access point for the neighborhood, even if this intersection is not close to the geometric center of the shape defined by the neighborhood.

In some implementations, the access point selector 124 uses the model 128 to obtain several candidate access points and directs the navigation application 142 to prompt the user regarding a selection of one of these access points as the destination.

For further clarity, several examples of providing navigation directions using the known techniques and the techniques of this disclosure are considered next in connection with FIGS. 2A-5B.

FIG. 2A illustrates an example user interface screen 200 which an existing mapping application can display to provide navigation directions to a shopping mall 201. As illustrated in FIG. 2A, the existing mapping application provides a route 202 that terminates on a road on the north side of the shopping mall 201. Although the route 202 correctly guides the user to the shopping mall 201, the end point of the route 202 may not be the best access point for the user.

On the other hand, FIG. 2B schematically illustrates a set of access points 204 which the database 110 can store, and from which the access point selector 124 can select an access point in response to a request for navigation directions to the mall 201 of FIG. 2A. The user may have identified the mall 210 by typing the name of the mall into an input box displayed by the navigation application 142, speaking a voice command that references the mall, selecting an end point of navigation directions on an interactive digital map via a long-press gesture (where the end point is inside the mall 201), etc. The database 110 also can store a two-dimensional shape 203 to which the name of the mall 201 is logically mapped and which encloses the received end point. Each of the access points 204 is inside the two-dimensional shape 203 or, in some cases on the perimeter of the two-dimensional shape 203. In this example scenario, the two-dimensional shape 203 generally coincides with the perimeter of shopping mall 201.

More particularly, the access points 204 can correspond to entrances located on the perimeter of the two-dimensional shape 203 and points of interest within the two-dimensional shape 203 (e.g., parking lots). As discussed above, the database 110 can store respective weights for the access points 204, so that the access point selector 124 can select an access point heuristically. In other implementations, the access point selector 124 can use the model 128 to determine which of the access points 204 is preferable for various combinations of contextual signals.

FIG. 2C illustrates an example user interface screen which the mapping and navigation application 142 can provide when displaying fine-tuned navigation directions to an access point within the two-dimensional shape 203 of FIG. 2B. The route 220 terminates at a preferred access point 222, which corresponds to one of the access points 204 of the two-dimensional shape 203 discussed with reference to FIG. 2B. In particular, the access point selector 124 in this scenario selected the preferred access point 222 from among the access points 204 using the techniques discussed above.

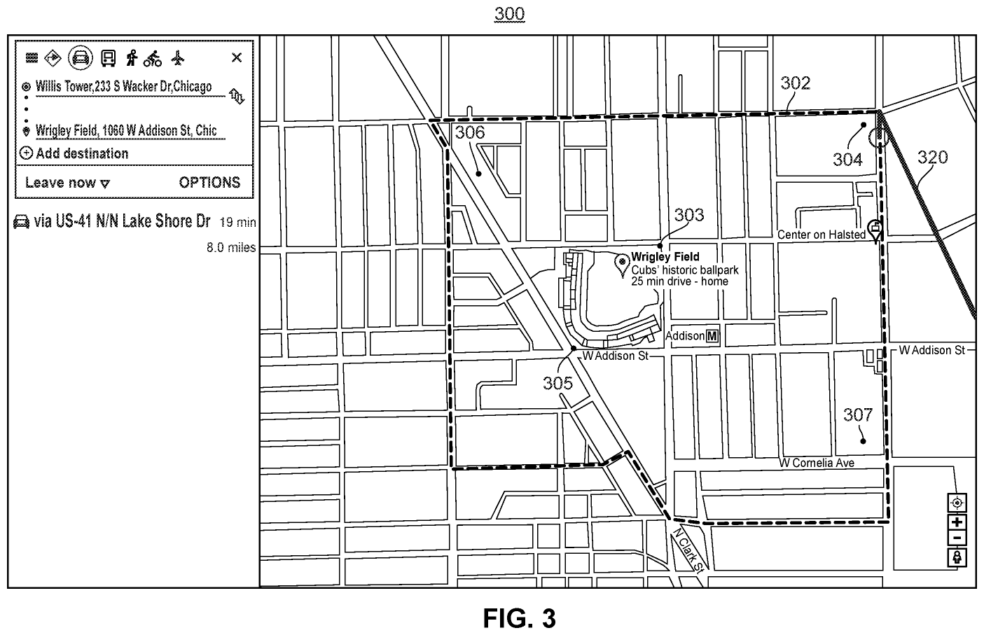

FIG. 3 illustrates another example user interface screen 300 including fine-tuned navigation directions the system of this disclosure can generate. In this example, the routing engine 122 generates the route 320 in response to a navigation request from a starting point (in this case, the Willis Tower in Chicago) to the end point which the navigation request identifies as “Wrigley Field.” The routing engine 122 guides the user to the preferred access point 304. The boundary detector 126 in this scenario associates the destination “Wrigley Field” with a two-dimensional shape 302 that encompasses a relatively large area around the stadium. The access point selector 124 can select a preferred access point for Wrigley Field from among the access points 303-307 within the shape 302. As discussed above, the boundary detector 126 can select the shape 302 in view of the time and the game schedule at the stadium. The access points 303-307 correspond to parking lots (304, 306, 307) and/or entrances to the stadium (303, 305). In this example, the access point selector 124 selects the point 304 in view of one or more contextual signals, and the routing engine 122 according generates a route 320 that terminates at the access point 304.

In some cases, the routing engine 122 may provide multi-segmented and/or follow-up navigation directions. For example, when the user completes the trip to the preferred access point 304, the routing engine 122 can generate navigation directions to the access point 303, which is not the preferred access point but is more proximate to the likely ultimate destination.

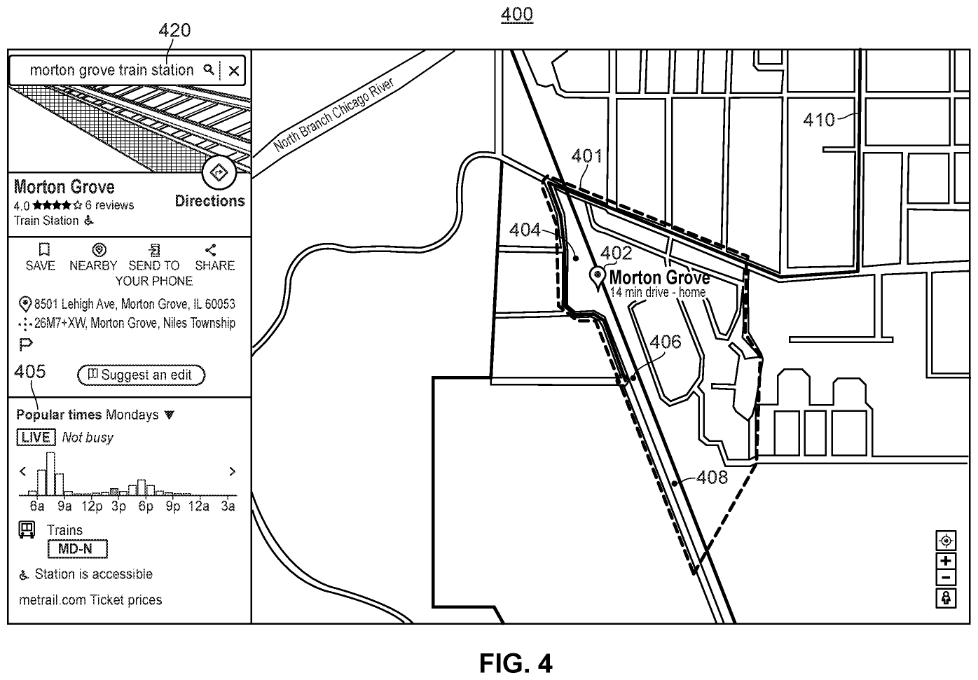

FIG. 4 is another example interface 400 illustrating fine-tuned navigation directions which the routing engine 122 can generate. Here, user input 420 identifies a train station in a certain town, and an existing geographic service can store a point identified in FIG. 3 by a marker 402 as the location of the station.

The boundary detector 126 identifies an area enclosed by a two-dimensional shape 401 as encompassing access points for the train station. As illustrated in FIG. 3, the train station is near a number of parking lots corresponding to access points 404, 406, and 408. In response to a request for navigation directions to the train station received from a driver, an existing geographic application typically attempts to generate navigation directions to the point 402, and the navigation directions can terminate at a point on a street near the train station. On the other hand, the access point selector 124 can select one of the access points 404, 406, or 408 as the preferred access point, and the routing engine 122 can generate navigation directions to the corresponding location.

Similar to the examples above, the access point selector 124 can select the preferred access point in view of various signals, including one or more contextual signals. For example, in some cases the access point selector 124 may determine that the access point 404 corresponding to the parking lot nearest the train station likely is occupied after a morning rush hour (the model 128 can determine that this is the case based on the training data that indicates that users arriving at the access point 404 at a certain hour turn around and park elsewhere, for example). The access point selector 124 accordingly can select another parking lot 406 which may be farther from the train station, but likely has available parking spaces at the estimated arrival time.

Referring back to FIG. 1B, the model 128 additionally can receive, as part of the training data set, indications of multiple trajectories to the train station from various users, and determine common termination points for these trajectories for several different times. For example, the training data set may indicate that until 9:00 am on Monday mornings, users commonly end their trips near the access point 404, from 9:00 am until 11:00 am users end their trips near the access point 406, and after 11:00 am users typically end their trips near the access point 408. The model 128 then can output the access point 404 during the first time interval, the access point 406 during the second time interval, etc. as the refined coordinates 191 in view of contextual signals that indicate the time of day and day of the week.

As indicated above, even after the model 128 is sufficiently trained, the server 104 can continue to receive new data from users. The access point selector 124 can continue to tune the model 128 and select access points further in view of sudden changes relative to the previously received historical data. For example, when users on a certain day start to avoid one of the parking lots 404, 406, or 408, or if users do not end their trips at the preferred access point suggested by the routing engine 122, the access point selector 124 can make quick adjustments to the model 128 by weighing the more recently received data more aggressively when providing new input to the model 128. Similarly, when the access point selector 124 uses signals related to the parking lots 404, 406, or 408 heuristically, the access point selector 124 can re-rank the parking lots 404, 406, or 408 in real time. As a more particular example, a number of users may begin to end their routes near the access point 406 prior to 9 am, which may indicate that there is a temporary event making the access point 404 an unsuitable access point. The access point selector 124 accordingly may select the access points 406 and 408 as a preferred destination for navigation directions to train station at times earlier than normal (in this example, prior to 9:00 am and 11:00 am, respectively).

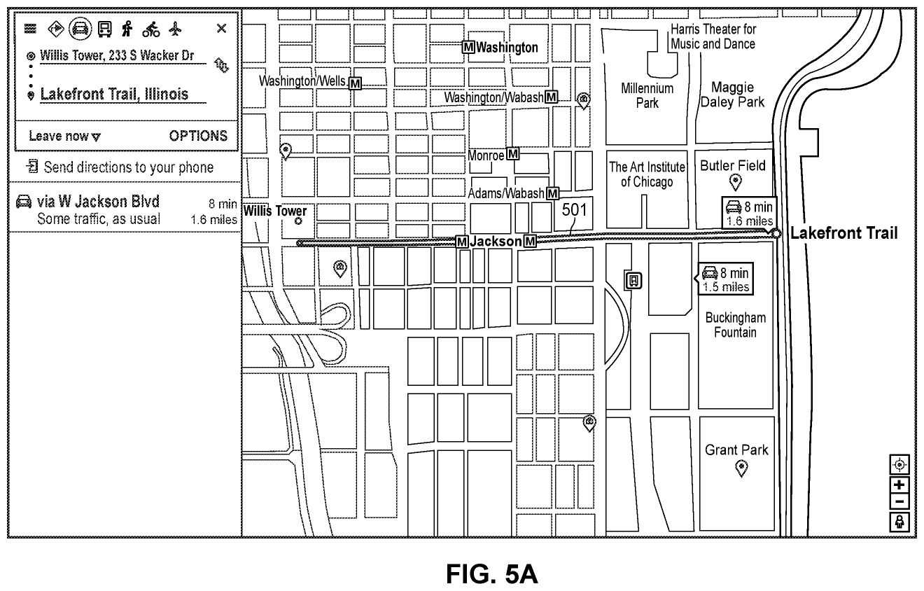

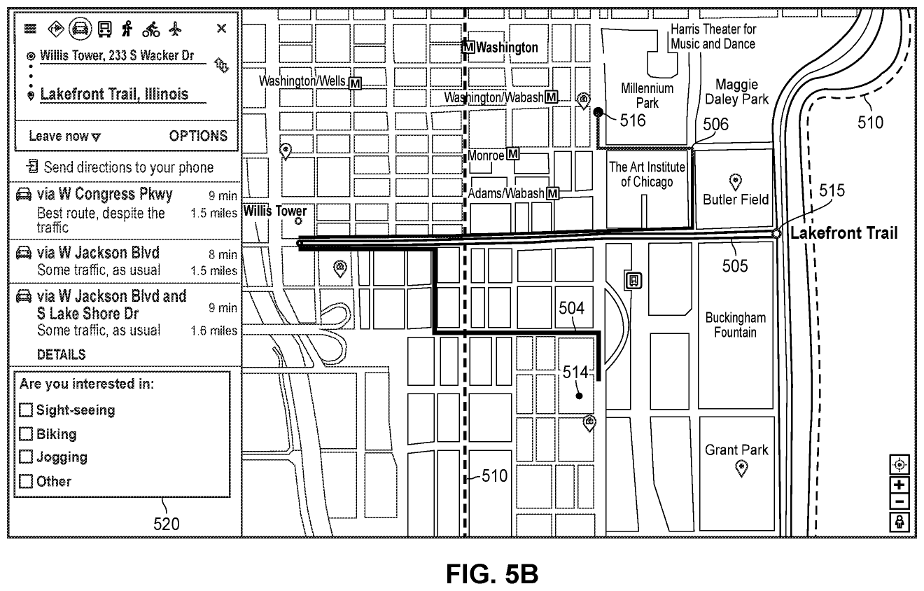

Next, FIG. 5A illustrates is another example user interface screen which an existing mapping application can generate to provide directions to a point on a lake front trail used for hiking, running, and biking. The route 501 is a route that terminates at a point on a road closest to a point on the lake front trail. However, there may not be an entrance to the trail at the point where the route 501 terminates, or parking may not be allowed at this location.

In contrast, FIG. 5B illustrates several example routes to preferred access points, which the routing engine 122 can generate. The point of the lake front trail in the navigation request may be logically mapped to a large two-dimensional shape 510 that encompasses a large portion of the lake front and includes multiple access points 514-516.

In one scenario, the access point selector 124 selects the access point 514, where a parking lot near the entrance of a bike portion of the lake front trail is located. The routing engine 122 accordingly can generate a route 504. The access point selector 124 can select the access point 514 when the user's profile indicates that he or she is a bike rider, or when the mapping application was accessed through a biking website, for example.

In another example scenario, the access point selector 124 selects the access point 515, where an entrance to lake front path is located. In this case, a contextual signal can include a request for walking directions to the lake front trail, and/or a user profile that indicates interest in jogging. As another example of a contextual signal, the request for navigation directions can arrive at a time that is commonly associated jogging on the lake front trail, such as early on a Saturday morning. In yet another scenario, the access point 516 may correspond to a scenic portion of the lake front trail. The access point selector 124 may select the access point 516 for a tourist.

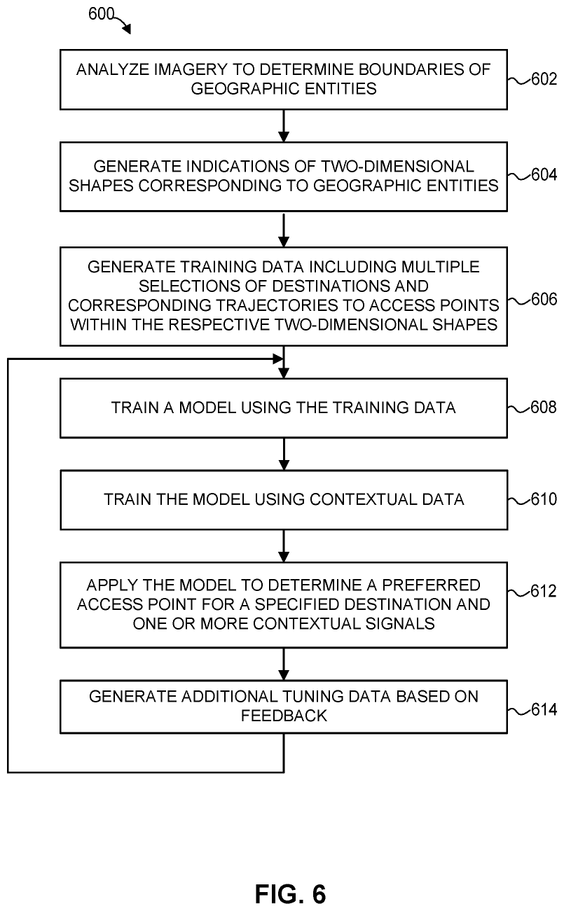

Several example methods that can be implemented in the system of FIG. 1A are discussed next with reference to FIGS. 6-8.

Referring first to FIG. 6, an example method 600 for determining a preferred access point for a destination using a machine learning model can be implemented as a set of instructions stored on a computer-readable memory and executable by one or more processors the server 104. For convenience, the method 600 is discussed below with reference to the routing engine 122, the access point selector 124, the detector 126 of FIG. 1A, collectively referred to as the navigation system, and the access point machine learning model 128 of FIGS. 1A and 1B. The navigation system can execute the method 600 periodically in a batch mode, for example, to populate or re-populate the corresponding records in the map database 110. In this manner, the navigation system can quickly and efficiently apply the model 128 in real time when servicing a request for navigation directions.

At block 602, the navigation system (e.g., the boundary detector 126) can determine boundaries of geographic entities in certain areas. The navigation system can receive the boundaries from various sources such as geographic information systems, users submitting user-generated content (UGC), municipal databases, etc. In some cases, the navigation system analyzes satellite imagery, street-level imagery, user-submitted photographs, etc. to detect physical boundaries between areas and various properties. These boundaries can be natural (e.g., rivers) or artificial (e.g., walls, fences). The navigation system can implement a classifier that identifies physical boundaries in imagery and determines the dimensions of such boundaries.

At block 604, the navigation system can use the boundaries at boundaries obtained at block 602 to generate indications of two-dimensional shapes corresponding to various geographic entities. The navigation system then can store descriptions of these two-dimensional shapes in a map database in any suitable format. For example, the navigation system can generate descriptions of polygonal boundaries of the two-dimensional shapes in a vector graphics format and store these descriptions as the two-dimensional shapes 111 in the map database 110.

Next, at block 606, the navigation system can generate training data for training a machine learning model configured to output access points for various destinations (see block 612 below). The training data can include anonymized historical logs including destinations to which users requested navigation directions, in various formats: “41.8789 N, 87.6359” (the coordinates of the Willis Tower in Chicago, Ill.), “the Willis Tower,” “233 South Wacker” (the street address of the main entrance of the Willis Tower), “Wacker & Jackson” (one of the intersections near the Willis Tower), etc. The training data further can include the corresponding anonymized trajectories that indicate where the users actually travelled after the navigation system provided the navigation directions to these destinations. Referring back to FIG. 1B, for example, the feature extraction functions 150 can determine the locations at which users eventually arrive after completing the corresponding navigation sessions (e.g., an entrance 100 meters away from the location at which navigation directions completed), the delays associated with the extra travel, whether the users tended to turn around or back track after completing the navigation sessions, and use these metrics as labels. As discussed in more detail with reference to FIG. 1B, the training data also can include various contextual signals related to sources of requests for navigation directions (types of applications, types of websites), the types of users submitting requests for navigation directions (e.g., tourists, locals), time of day, season, weather, etc.

The navigation system can group the training data by locations within two-dimensional shapes. Thus, a two-dimensional shape corresponding to the Willis Tower in the example above can encompass multiple points to which users travelled after requesting navigation directions to the coordinates, the street address, etc. of the Willis Tower.

The navigation system then can use the training data to train the model at block 608 and, when contextual signals are available, further train the model using contextual data at block 610. Although FIG. 6 depicts blocks 608 and 610 in a sequential order, it will be understood that when contextual data is available, the feature extraction functions 150 can generate feature vectors including travel data along with additional contextual signals, and effectively apply the data at block 608 and 610 in parallel.

At block 610, the navigation system can apply the model to determine a preferred access point for a certain set of inputs. More particularly, the navigation system can receive a request for navigation directions to a certain location identified by geographic coordinates, a street address, the name of a landmark, etc. from a user device and, in some cases, one or more contextual signals, and the navigation system can apply the model to generate refined geographic coordinates, a refined street address, etc. The navigation system can provide fine-tuned navigation directions to the refined destination to the requesting user device.

The navigation system also can detect implicit or explicit feedback regarding the fine-tuned navigation directions, generate additional tuning data based on the feedback at block 614, and use this tuning data to further train the model, as discussed with reference to FIG. 1B. The flow accordingly returns to block 608.

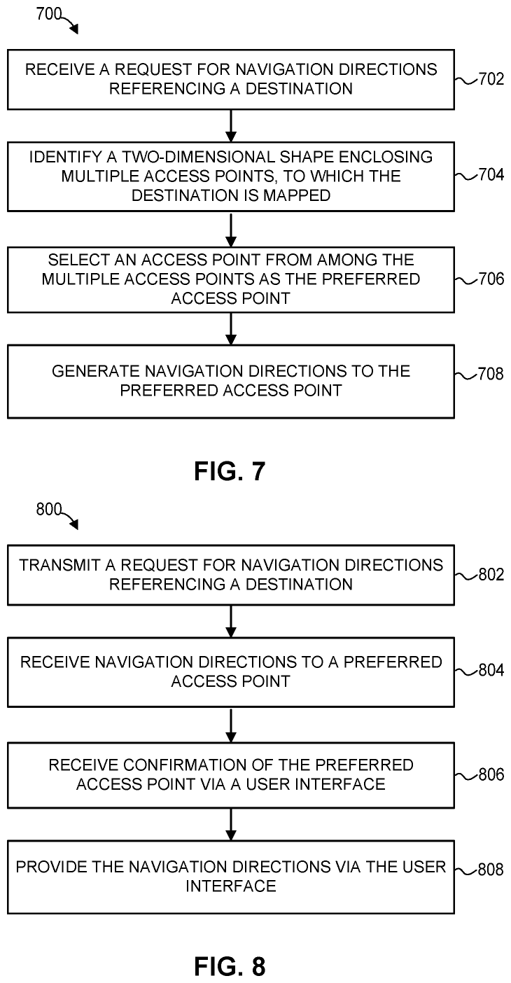

Next, FIG. 7 illustrates a flow diagram of an example method 700 for generating fine-tuned navigation directions. The method 700 may be implemented as a set of instructions stored on a computer-readable memory and executable by one or more processors of the client computing device 102 and/or the server device 104. For convenience, the method 700 also is discussed below with reference to the routing engine 122, the access point selector 124, and boundary detector 126 of FIG. 1, collectively referred to as the navigation system.

At block 702, the navigation system may receive a request for navigation directions including a start point and a destination, or an end point. The request can be received via a user interface of a client device, for example. The destination can include geographic coordinates (e.g., latitude and longitude), a street address, the name of the landmark (e.g., Wrigley Field or the Willis Tower, as discussed above), the colloquial name of a neighborhood (e.g., Mission), the name of a natural park, etc. The destination in general can correspond to a location of any size or level of granularity. In at least some of the implementations, the destination can correspond to a certain point identifiable by geographic coordinates. For example, as discussed above with reference to FIG. 4, a geographic database can store the coordinates of a certain point for a train station.

After the navigation system receives the request for navigation directions, the navigation system may identify a two-dimensional shape to which the destination is logically mapped, at block 704. For example, users operating respective user devices can select similar but not identical points on an interactive digital map using long-press gestures, and the navigation system can map all of these points to the same geographic entity. As another example, users can request navigation directions to different stores with different respective addresses in a same shopping mall, and the navigation system at block 704 in each instance can map the addresses to the two-dimensional shape encompassing the shopping mall.

In some cases, certain coordinates or street addresses can be logically mapped to multiple two-dimensional shapes. Further, the navigation system in some cases can store multiple two-dimensional shapes for the same geographic entity, to be used in different scenarios. For example, as discussed above, the navigation system can store a smaller two-dimensional shape for a baseball stadium to be used when no games are in progress, and a larger two-dimensional shape for the same baseball stadium to be used during games. Referring back to FIG. 1, the navigation system can store these shapes as two-dimensional shapes 111 in the database 110.

At block 706, the navigation system can select a preferred access point from among the multiple access points enclosed by the two-dimensional shape as a preferred destination for the navigation directions. To this end, the navigation system in various implementations can use contextual signals heuristically or can use the contextual signals with a machine-learning model as discussed above. After the navigation system has identified a preferred access point, the navigation system can generate navigation directions to the preferred access point and provide these navigation directions to the requesting device.

FIG. 8 illustrates a flow diagram of an example method for providing fine-tuned navigation directions at a client device. The method 800 may be implemented in a set of instructions stored on a computer-readable memory and executable by one or more processors of the client computing device 102. For convenience, the method 800 is discussed below with reference to the mapping application 142 of FIG. 1.

At block 802, the mapping application 142 can transmit a request for navigation directions to a network server such as the server 104. The request for navigation directions includes the origin or the start point, which can be the current location of the user device 102, and a destination. To determine the destination, the mapping application 142 can provide an interactive interface for specifying a destination, which can be an interactive digital map, a pop-up window related to a geographic location including a control for requesting navigation directions to this location, an input box for text input, a prompt for audio input, etc. As discussed above with reference to block 702, the destination can conform to any suitable format.

At block 804, the mapping application 142 can receive navigation directions to the preferred access point which can be different from the destination included in the request for navigation directions. The mapping application 142 then can request a confirmation that the user wishes to navigate to the preferred access point at block 806. At block 808, the mapping application 142 can provide the received navigation directions via the user interface.

In some cases, when the user has indicated that the server 104 may use the user's trajectory to fine-tune the machine learning model, the server 104 can apply the trajectory the user follows upon completing the navigation session to the preferred access point to the machine-learning model (e.g., the model 128 of FIGS. 1A and 1B). For example, the adjustment function 198 of FIG. 1B can apply, to the model 128, a metric that indicates the distance in between the preferred access point and the location to which the user eventually travelled.

### Additional Considerations

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Additionally, certain embodiments are described herein as including logic or a number of components, modules, or mechanisms. Modules may constitute either software modules (e.g., code stored on a machine-readable medium) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term hardware should be understood to encompass a tangible entity, be that an entity that is physically constructed, permanently configured (e.g., hardwired), or temporarily configured (e.g., programmed) to operate in a certain manner or to perform certain operations described herein. As used herein “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configured on a processor, for example, to constitute a particular hardware module at one instance of time and to constitute a different hardware module at a different instance of time.

Hardware modules can provide information to, and receive information from, other hardware. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The methods 600 and 700 may include one or more function blocks, modules, individual functions or routines in the form of tangible computer-executable instructions that are stored in a non-transitory computer-readable storage medium and executed using a processor of a computing device (e.g., a server, a personal computer, a smart phone, a tablet computer, a smart watch, a mobile computing device, or other personal computing device, as described herein). The methods 600 and 700 may be included as part of any backend server (e.g., a map data server, a navigation server, or any other type of server computing device, as described herein), portable device modules of the example environment, for example, or as part of a module that is external to such an environment. Though the figures may be described with reference to the other figures for ease of explanation, the methods 600 and 700 can be utilized with other objects and user interfaces. Furthermore, although the explanation above describes steps of the methods 600 and 700 being performed by specific devices (such as a client computing device 102, and a server 104), this is done for illustration purposes only.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as an SaaS. For example, as indicated above, at least some of the operations may be performed by a group of computers (as examples of machines including processors), these operations being accessible via a network (e.g., the Internet) and via one or more appropriate interfaces (e.g., APIs).

Still further, the figures depict some embodiments of the example environment for purposes of illustration only. One skilled in the art will readily recognize from the following discussion that alternative embodiments of the structures and methods illustrated herein may be employed without departing from the principles described herein.

Upon reading this disclosure, those of skill in the art will appreciate still additional alternative structural and functional designs for generating navigation routes through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1. A computer-implemented method for providing navigation directions, the method comprising:
receiving, by one or more processors, a request for navigation directions to a destination;
identifying, by the one or more processors, a two-dimensional shape enclosing a plurality of access points, to which the destination is logically mapped;
selecting, by the one or more processors, an access point from the plurality of access points as a preferred destination; and
generating, by the one or more processors, navigation directions to the preferred destination in response to the request.

2. The computer-implemented method of claim 1, further comprising:
training, by the one or more processors, a machine learning model that outputs an access point based on a destination, including applying training data that includes (i) a plurality of destinations to which users requested navigation directions and (ii) for each of the plurality of destinations, respective locations to which the users travelled after completing respective navigation sessions to the corresponding destinations, wherein at least a subset of the locations defines the plurality of access points;
wherein the identifying and the selecting include applying the destination to the machine learning model.

3. The computer-implemented method of claim 2, wherein training the machine learning model includes applying boundary data that indicates boundaries of two-dimensional shapes associated with respective ones of the plurality of destinations.

4. The computer-implemented method of claim 2, wherein training the machine learning model includes applying trajectory data that indicates, for at least some of the navigation sessions, trajectories made up of position and time tuples.

5. The computer-implemented method of claim 2, wherein training the machine learning model includes applying contextual signals for at least some of the navigation sessions, and wherein the identifying and the selecting include applying a contextual signal related to the request for navigation directions to the machine learning model.

6. The computer-implemented method of claim 5, wherein a contextual signal for a navigation session includes at least one of:
(i) requestor data identifying at least one of (i) a type of activity to which the navigation session pertains or (ii) user preferences,
(ii) a time at which the navigation session occurred,
(ii) weather during the navigation session,
(iv) a temporary event occurring at the destination at a time of the navigation session, or
(v) a mode of transport to which the navigation session pertains.

7. The computer-implemented method of claim 2, wherein training the machine learning model further includes initializing the model using probabilities inversely proportional to distances between access points and geographic coordinates associated with the destinations.

8. The computer-implemented method of claim 1, wherein the destination is a first street address, and wherein selecting the access point includes selecting a second street address different from the first street address.

9. The computer-implemented method of claim 8, wherein the first street address and the second street address correspond to two respective entrances to a building.

10. The computer-implemented method of claim 1, wherein the destination is a set of geographic coordinates, and wherein selecting the access point includes selecting a street address.

11. The computer-implemented method of claim 1, wherein the destination is a geographic entity including multiple parking locations, and wherein selecting the access point includes selecting one of the multiple parking locations.

12. The computer-implemented method of claim 1, wherein identifying the two-dimensional shape includes processing imagery of a geographic area that includes the destination to identify physical boundaries of the destination.

13. (canceled)

14. A client device comprising:
one or more processors;
a user interface;
a non-transitory computer-readable memory storing instructions that, when executed by the one or more processors, cause the client device to:
transmit, to a server via a communication network, a request for navigation directions to a destination,
receive, in response to the request, navigation directions to an access point selected from a plurality of access points logically mapped to a two-dimensional area including the destination, and
provide the navigation directions via the user interface.

15. The client device of claim 14, wherein the request for navigation directions includes a street address of the destination, and wherein the access point corresponding to a street address different from the street address of the destination.

16. The client device of claim 15, wherein the request for navigation directions includes geographic coordinates of the destination, and wherein the access point includes a street address.

17. A method in a computing system for determining a preferred access point for a destination, the method comprising:
determining, by one or more processors, a two-dimensional shape representing a geographic area including a geographic entity;
generating, by the one or more processors, training data that includes (i) a plurality of destinations to which users requested navigation directions and (ii) for each of the plurality of destinations, respective locations within the geographic area to which the users travelled after completing respective navigation sessions to the corresponding destinations;
training, by the one or more processors using the training data, a machine learning model; and
identifying, using the machine learning model, a preferred access point for a certain destination.

18. The method of claim 17, wherein determining the two-dimensional shape processing imagery of a geographic area that includes the geographic entity to identify physical boundaries.

19. The method of claim 17, wherein the training data further includes contextual signals for at least some of the navigation sessions, and wherein a contextual signal for a navigation session includes at least one of:
(i) requestor data identifying a type of activity to which the navigation session pertains,
(ii) a time at which the navigation session occurred,
(ii) weather during the navigation session,
(iv) a temporary event occurring at the destination at a time of the navigation session, or
(v) a mode of transport to which the navigation session pertains.

20. The method of claim 17, further comprising:
providing, in response to a request for navigation directions to the destination, navigation directions to the preferred access point;
receiving, by the one or more processors, feedback data indicative of a distance between the preferred access point and a location of a user device after completing a navigation session according to the navigation directions; and
further training the machine learning model using the feedback data.
